(19) United States
(12) Patent Application Publication
(10) Pub. No.: US 2018/0025320 A1
(43) Pub. Date: Jan. 25, 2018

(54) Correlating Courier Information and Providing Logistics Content Information

(71) Applicant: Alibaba Group Holding Limited, Grand Cayman (KY)

(72) Inventors: Shuyan Liu, Zhejiang (CN); Tian Zhang, Zhejiang (CN)

(73) Assignee: Alibaba Group Holding Limited

(21) Appl. No.: 15/724,085

(22) Filed: Oct. 3, 2017

Related U.S. Application Data
(63) Continuation of application No. PCT/CN2016/076882, filed on Mar. 21, 2016.

(30) Foreign Application Priority Data
Apr. 8, 2015 (CN) 201510164150.0

(51) Int. Cl. G06Q 10/08; G06F 21/62; G06F 17/30; G06K 7/14

(52) U.S. Cl. CPC G06Q 10/0838; G06K 7/1413; G06F 21/6218; G06F 17/30864; G06K 2007/10504

(57) ABSTRACT

A method correlating logistics information includes: receiving logistics information entered for a target transaction order; determining a target transaction object identification associated with the target transaction order; determining target object description information corresponding to the target transaction object identification; determining an identification code, wherein the identification code is printed on a target courier waybill in a form of graphic code; and establishing and storing a corresponding relationship between the identification code and the target object description information, such that when the graphic code on the target courier waybill is scanned by an image capturing device, the target object description information is displayed at the image capturing device to provide a preview of the product in the corresponding courier parcel. The present disclosure helps correctly deliver the carrier parcel.

### CROSS REFERENCE TO RELATED PATENT APPLICATIONS

This application claims priority to and is a continuation of PCT Patent Application No. PCT/CN2016/076882; filed on 21 Mar. 2016, which claims priority to Chinese Patent Application No. 201510164150.0, filed on 8 Apr. 2015, entitled “Method and Device for Correlating Courier Information and Providing Logistics Content Information,” which are hereby incorporated by reference in their entirety.

### TECHNICAL FIELD

The present disclosure relates to the technology field of processing logistics information, and, more particularly, to a method and apparatus for correlating courier information and providing logistics content information.

### BACKGROUND

With the continuous improvement of the e-commerce trading platform and the rapid development of traditional communications and mobile communication technology, more and more people order their desired products through online shopping. The type of products can relate to every aspect of people's daily lives. Buyers only need to place an order through a client terminal of the e-commerce platform (such as a website or mobile application), pass through a series of processing such as the seller shipping, logistics and distribution, and ultimately receive the products without leaving home. The distribution of products is a very critical part. If the product is sent to the wrong recipient, the buyer or the seller will have loss.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The present disclosure provides a method and apparatus for correlating courier information and providing logistics content information, which helps to achieve correct parcel delivery.

The present disclosure provides the following solutions.

The present disclosure provides a method comprising:

extracting, by a client terminal, an identification code of a carrier parcel;

searching target object description information associated with the identification code according to a pre-stored corresponding relationship between the identification code and the target object description information, the target object description information including information of a product within the carrier parcel; and

displaying the target object description. information to preview the product.

For example, the displaying the target object description information to preview the product includes displaying the product using augmented reality without opening the carrier parcel.

For example, the extracting the identification code of the carrier parcel includes:

scanning a graphic code on a carrier waybill of the carrier parcel; and

extracting the identification code from the graphic code.

For example, the displaying the target object description information to preview the product includes:

determining a location of the scanned graphic code on a screen of the client terminal; and

displaying the target object description information on the location.

For example, the searching target object description information associated with the identification code includes:

submitting the identification code to a server to determine the target object description information associated with the identification code; and

receiving the target object description information from the server.

For example, the method may further comprise:

presenting an interface to receive preview privilege information; and

obtaining the target object description information to preview the product according to the preview privilege information.

The present disclosure also provides another method comprising:

determining, by a server, a target transaction object identification associated with a target transaction order;

determining target object description information corresponding to the target transaction object identification;

determining an identification code of a target courier waybill; and

establishing and storing a corresponding relationship between the identification code and the target object description information.

For example, the identification code is printed on the target courier waybill in a form of graphic code.

For example, the method may further comprise:

receiving a request to obtain the target object description information from a client terminal;

extracting the identification code from the request; and

determining the target object description information associated with the identification code according to the corresponding relationship.

For example, the method may further comprise transmitting the target object description information to the client terminal.

For example, the method may further comprise establishing a database of transaction object content description information that stores the corresponding relationship.

For example, the determining the target object description information corresponding to the target transaction object identification includes:

searching the database; and

determining the target object description information corresponding to the target transaction object identification.

For example, the determining the target object description information corresponding to the target transaction object identification includes:

obtaining detailed description information of the target transaction object; and

extracting the target object description information corresponding to the target transaction object from the detailed description information.

For example, the determining the identification code includes:

extracting a target carrier waybill identification from logistics information of the target transaction order; and

determining the target carrier waybill identification as the identification code.

For example, the method may further comprise:

generating a graphic code as the identification code according to the generated identification code; and

returning the generated graphic code to be printed on the target carrier waybill.

For example, the method may further comprise:

determining preview privilege information associated with the target transaction order; and

storing the preview privilege information.

For example, the method may further comprise:

receiving preview privilege information from a client terminal; and

comparing the preview privilege information from the client terminal with the preview privilege information associated with the target transaction order to provide the target object description information for preview at the client terminal.

The present disclosure also provides another method comprising:

providing a preview privilege setting option to set corresponding preview privilege information for preview a product within a carrier parcel;

receiving preview privilege information through the preview privilege: setting option; and

storing a corresponding relationship between an identification of a transaction order for the product and the preview privilege information.

For example, the preview privilege information includes password information.

For example, the method may further comprise conducting a privilege control to preview the product based on the preview privilege information.

The techniques of the present disclosure, as illustrated by the example embodiments of the present disclosure, establish a corresponding relationship between the identification code and the target object description information of the specific transaction object and print the graphic code information corresponding to the identification code on the carrier waybill. The image capturing device may be used to scan the graphic code on the carrier waybill and display the specific target object description information on the screen of the image capturing device. Thus, there is no need to open the carrier package to know the transaction object content in the carder parcel, which helps to accurately deliver the carrier package.

Certainly, a product that implements the present disclosure does not need to have all of the above technical advantages.

### BRIEF DESCRIPTION OF THE DRAWINGS

In order to more clearly illustrate the technical solutions in the embodiments or the conventional techniques of the present disclosure, the drawings for illustrating the embodiments are briefly introduced as follows. It is apparent that the FIGs only describes some of the embodiments of the present disclosure. One of ordinary skill in the art may obtain other figures according to the FIGS without using creative efforts.

FIG. 1 is a flowchart illustrating a first method according to an embodiment of the present disclosure;

FIG. 2 is a flowchart of a second method according to an embodiment of the present disclosure;

FIG. 3 is a flowchart illustrating a third method according to an embodiment of the present disclosure;

FIG. 4 is a flowchart illustrating a fourth method according to an embodiment of the present disclosure;

FIG. 5 is a schematic view of a first apparatus according to an embodiment of the present disclosure;

FIG. 6 is a schematic view of a second apparatus according to an embodiment of the present disclosure;

FIG. 7 is a diagram illustrating a third apparatus according to an embodiment of the present disclosure; and

FIG. 8 is a diagram illustrating a fourth apparatus according to an embodiment of the present disclosure.

### DETAILED DESCRIPTION

In conjunction with the following FIGs of the present disclosure, the technical solutions in the embodiments of the present disclosure will be clearly and completely described, Apparently, the described embodiments are merely some embodiments of the present disclosure and do not constitute limitation to the present disclosure. All other embodiments obtained by those of ordinary skill in the art based on the embodiments of the present disclosure fall within the scope of protection of the present disclosure.

In the embodiment of the present disclosure, the waybill number is associated with the specific product for delivery. Thus, when there is a need to know the specific product in the carrier package, the image capturing device is used to scan the waybill number attached on the parcel. Then the information of the corresponding product is displayed by the image capturing device. In other words, the detailed product content is known without opening the package, which prevents from delivering incorrect product. The detailed implementations are described as follows.

The present disclosure provides the following solutions.

The present disclosure provides a method for correlating courier information, which includes:

receiving logistics information entered for a target transaction order;

determining a target transaction object identification associated with the target transaction order;

determining target object description information corresponding to the target transaction object identification;

determining an identification code, wherein the identification code is printed on a target courier waybill in a form of graphic code; and

establishing and storing a corresponding relationship between the identification code and the target object description information, such that when the graphic code on the target courier waybill is scanned by an image capturing device, the target object description information is displayed at the image capturing device to provide a preview of the product in the corresponding courier parcel.

The present disclosure also provides a method for providing logistics content information, including:

A server pre-stores a corresponding relationship between an identification code and target object description information.

When a request to obtain target object description information is received from a client terminal, information of the identification code is extracted from the request. After the graphic code on the target courier waybill is obtained via scanning by an image capturing device, the client terminal analyzes and extracts the identification code from the graphic code and sends the request.

The target object description information associated with the identification code is determined according to the pre-stored corresponding relationship.

The target object description information is returned so that a terminal device where the client terminal resides displays the target object description information to preview the product in the corresponding carrier parcel.

The present disclosure also provides a method for providing logistics content information, including:

A client terminal extracts an identification code from a scanned graphic code. The graphic code is a graphic code printed on a carrier waybill.

The identification code is submitted to a server so that the server determines and returns target object description information associated with the identification code according to a pre-stored corresponding relationship between the identification code and the target object description information.

After the target object description information is received from the server, the client terminal displays the target object description information to preview the product in the carrier parcel.

The present disclosure also provides a method for generating a transaction order, which includes:

providing a preview privilege setting option when generating a transaction order for a transaction object, wherein the preview privilege setting option is used to set corresponding preview privilege information when a content within a carrier parcel is previewed by scanning the graphic code printed on the carrier waybill;

receiving preview privilege information through the preview privilege setting option; and

storing a corresponding relationship between an identification of the transaction order and the preview privilege information.

The present disclosure provides an apparatus for correlating courier information, which includes:

a logistics information receiving unit that receives logistics information entered for a target transaction order;

a target object identification determining unit that determines a target transaction object identification associated with the target transaction order;

a target object description information determining unit that determines target object description information corresponding to the target transaction object identification;

an identification code determining unit that determines an identification code, wherein the identification code is printed on a target courier waybill in a form of graphic code; and

a corresponding relationship establishing unit that establishes and stores a corresponding relationship between the identification code and the target object description information, such that when the graphic code on the target courier waybill is scanned by an image capturing device, the target object description information is displayed at the image capturing device to provide a preview of the product in the corresponding courier parcel.

The present disclosure also provides an apparatus for providing logistics content information, which includes:

a corresponding relationship storing unit that a server pre-stores a corresponding relationship between an identification code and target object description information;

an identification code extracting unit that, when a request to obtain target object description information is received from a client terminal, extracts information of the identification code from the request. After the graphic code on the target courier waybill is obtained via scanning by an image capturing device, the client terminal analyzes and extracts the identification code from the graphic code and sends the request;

a target object description information determining unit that determines the target object description information associated with the identification code according to the pre-stored corresponding relationship; and

a target object description information returning unit that returns the target object description information so that a terminal device where the client terminal resides displays the target object description information to preview the product in the corresponding carrier parcel.

The present disclosure also provides an apparatus for providing logistics content information, which includes:

an identification extracting unit that extracts an identification code from a scanned graphic code. The graphic code is a graphic code printed on a carrier waybill;

a submitting unit that submits the identification code to a server so that the server determines and returns target object description information associated with the identification code according to a pre-stored corresponding relationship between the identification code and the target object description information.

a target object description information displaying unit that, after the target object description information is received from the server, displays the target object description information to preview the product in the carrier parcel.

The present disclosure also provides an apparatus for generating a transaction order, which includes:

a setting option providing unit that provides a preview privilege setting option when generating a transaction order for a transaction object, wherein the preview privilege setting option is used to set corresponding preview privilege information when the parcel content is previewed by scanning the graphic code printed on the carrier waybill;

a preview privilege information receiving unit that receives preview privilege information through the preview privilege setting option; and

a corresponding relationship storing unit that stores a corresponding relationship between an identification of the transaction order and the preview privilege information.

The first embodiment is as follows.

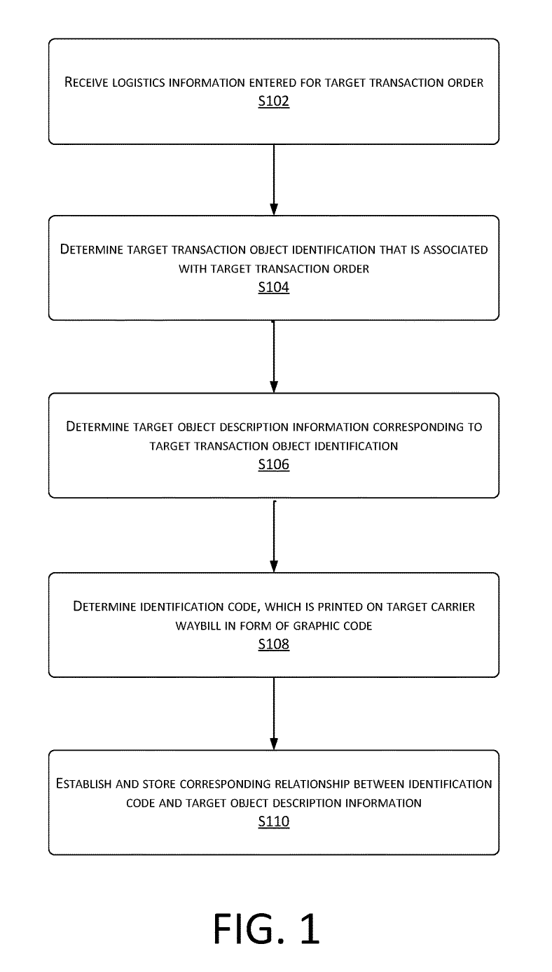

Referring to FIG. 1, this embodiment of the present disclosure firstly provides a method for providing correlated logistics information, which may include the following steps:

S102: the logistics information entered for target transaction order is received.

In this embodiment, an execution entity of each step may be a server of an e-commerce platform. In an e-commerce system, a buyer user conducts “making order” operation for a specific transaction object of a selected merchant. The system generates a transaction order for the order operation. Each transaction order corresponds to a unique order identifier in the system. The transaction order may also information of the detailed transaction object, such as an identifier, a specific model, color, and other attributes of the transaction object. The merchant will ship the product according to the transaction order.

After shipping the product according to the transaction order, the merchant will upload the logistics information into the system, which may include the specific name of the logistics company, waybill number, shipping time, etc. The information may be provided to the buyer user via a client terminal of the e-commerce platform so that the buyer user knows the logistics information of the ordered product. In the step S102, the logistics information entered by the merchant for the target transaction order is received.

S104: a target transaction object identification that is associated with the target transaction order is determined.

As the transaction order stores the detailed transaction object information, the transaction object identifier, such as the transaction object ID, associated with the target transaction order is determined.

S106: the target object description information corresponding to the target transaction object identification is determined.

After determining the target transaction object identification, the target object description information corresponding to the transaction object identification is determined. The target object description information may be information displayed by the image capturing device when a user uses the image capturing device to scan the waybill number on the waybill.

There are various specific implementations to determine the target object description information corresponding to the target transaction object. For example, in one implementation, as the merchant generally submits the detailed description information of the transaction objects when publishing the various transaction objects in the e-commerce platform system, such detailed description of the target transaction objects generally includes pictures of the displayed transaction objects. Thus, the detailed description information corresponding to the target transaction objects are extracted from the product detailed description database according to the target transaction objects, and then the pictures of the products are extracted therefrom as the target object description information corresponding to the target transaction object.

Alternatively, in another implementation, a database of transaction object content description information is pre-established, which stores the corresponding relationship between the transaction object identification and the target object description information. Thus, the target object description information corresponding to the target transaction object is directly determined through inquiring such database. For example, a structure of the database may be as shown in FIG. 1.

TABLE 1

| Serial | Transaction | Target Object |
|---|---|---|
| Number | Object ID | Description Information |
| 1 | ID 1 | Picture 1 |
| 2 | ID 2 | Picture 2 |
| . . . | . . . | . . . |

There are various methods to establish the database of transaction object content description information. For example, product pictures are extracted from detailed description information of the various transaction objects in advance, and saved as the target object description information in the database of transaction object content description information. Alternatively, to make the displayed information more colorful, the merchant may use 3D model to generate the target object description information of the various target objects, and upload them to the server of the e-commerce platform system. Thus, the target object description information stored in the database of transaction object content description information has 3D effects.

Certainly, in actual applications, the description information of the transaction object includes are not only in the form of pictures but also in the form of texts, audios, videos, flash, or a combination of various forms. That is, through the content description information, the content in the parcel is previewed.

S108: the identification code is determined. The identification code is printed on the target carrier waybill in a form of graphic code.

In addition to the determination of the target object description information, the identification code is determined. On one hand, the identification is associated with the waybill of the carrier parcel (the carrier parcel is the parcel to ship the target object of the current transaction order). On the other hand, through the implementation of the embodiment of the present disclosure, the identification code is also associated with the previously determined target object description information. That is, through the identification code, the waybill is associated with the target object description information.

There are various methods to determine the identification code. For example, in one implementation, the waybill provided by the logistics service provider is preprinted and there are preset spaces to fill in recipient, sender, and other information. In addition, each waybill is generally printed with a waybill number (usually a character string composed of characters and numbers) and a corresponding graphic code (usually in a form of barcode). The purpose of the graphic code is to let the computing system know the waybill number through scanning. Thus, the waybill number may be directly determined as the identification code. In the detailed implementation, as the embodiment of the present disclosure is implemented during the process that the seller user inputs the logistics information for the transaction order, while the logistics information input by the seller user generally includes the information of the waybill number, the information of the waybill number may be extracted from the logistics information and the information of the waybill number is used as the identification code. Thus, there is no need to print other graphic code on the waybill number. The parcel content may be previewed by directly scanning the barcode corresponding to the waybill number.

Alternatively, in another implementation, the identification code particularly for previewing the parcel content may be generated. For example, a character string is generated per a preset rule and the generated character string is different from those already generated. Such generated character string is determined as the identification code. Certainly, as the identification code is generated by the server at the transaction platform, the graphic code information corresponding to the identification code is not pre-printed on the waybill number. Thus, under this implementation, after the identification code is generated, the graphic code corresponding to the identification code is also generated. The graphic code may have many forms, such as a barcode, a two-dimensional barcode, or the identification code itself. The generated graphic code is returned to the client terminal of the seller user. Thus, when the client terminal of the seller user prints the information such as sender and recipient onto the waybill, the graphic code is also printed on some blank space of the waybill. Thus, the particular content within the parcel is previewed by scanning the particular graphic code.

S110: the corresponding relationship between the identification code and the target object description information is established and stored so that when the image capturing device scans the graphic code on the target carrier waybill, the product within the carrier parcel is previewed.

After the target object description information corresponding to the target transaction object and the identification code are determined, the corresponding relationship between the identification code and the target object description information is established and stored. Then, after the user subsequently uses the image capturing device to scan the graphic code corresponding to the identification code, the target object description information is displayed by the image capturing device. For example, when the user uses the image capturing device to scan the barcode corresponding to the target carrier waybill number or other particular graphic code, the content description information of the particular content within the parcel is actually displayed on the screen of the image capturing device so that the user knows the content in the parcel without opening the parcel.

When displaying the target object description information on the image capturing device, the augmented reality technology may be used. For example, when the image capturing device is used to scan the carrier waybill, the scanned object is the barcode displayed on the carrier waybill. Through scanning the barcode, the scanned target carrier waybill identification is determined. The target object description information is determined according to the corresponding relationship between the carrier waybill identification and the target object description information. Further, the target object description information is displayed by using the location of the barcode on the screen of the image capturing device as the coordinate. In other words, the viewing effects to the user is that the target object description information is displayed at the location of the scanned barcode, thereby improving display effect.

It is noted that in some actual applications some buyers don't want the carrier to view the transaction object within the carrier parcel by scanning the waybill number etc. With respect to this situation, the embodiment of the present disclosure also provides an option for the buyer user to set up preview privilege when the buyer user makes an order. If the buyer user needs to set up preview privilege, such setup may be done through the option. When the transaction order is generated, the set information of the privilege is also saved. Thus, when the logistics information of the target transaction order is received and the corresponding relationship between the identification code and the target object description information, the preview privilege information associated with the target transaction order is determined and the corresponding relationship between the identification code and the preview privilege information is saved.

There are various ways to set up the privilege. For example, the identity of the viewer that views the content of the parcel is restricted. For another example, a password may be set. When a user uses the image capturing device to scan the barcode on the carrier waybill, the password authentication may be used to control privilege. For instance, the user is required to input the password at first. When the input password matches the stored password, the detailed target object description information is displayed.

Overall, the embodiment of the present disclosure establishes a correlation relationship between the identification code and the target object description information corresponding to the specific transaction object and prints the graphic code information corresponding to the identification code on the carrier waybill. Thus, when the image capturing device is used to scan the graphic code on the carrier waybill, the detailed target object description information is displayed on the screen of the image capturing device. Thus, there is no need to open the carrier parcel to know the transaction object content within the parcel, which has a positive effect to correctly deliver the carrier parcel.

The second embodiment is as follows.

The first embodiment provides a detailed implementation of the corresponding relationship between the identification code and the target object description information. Such corresponding relationship is subsequently used to provide the target object description information to the user. The second embodiment provides the detailed implementation of providing the target object description information from the respective of the server.

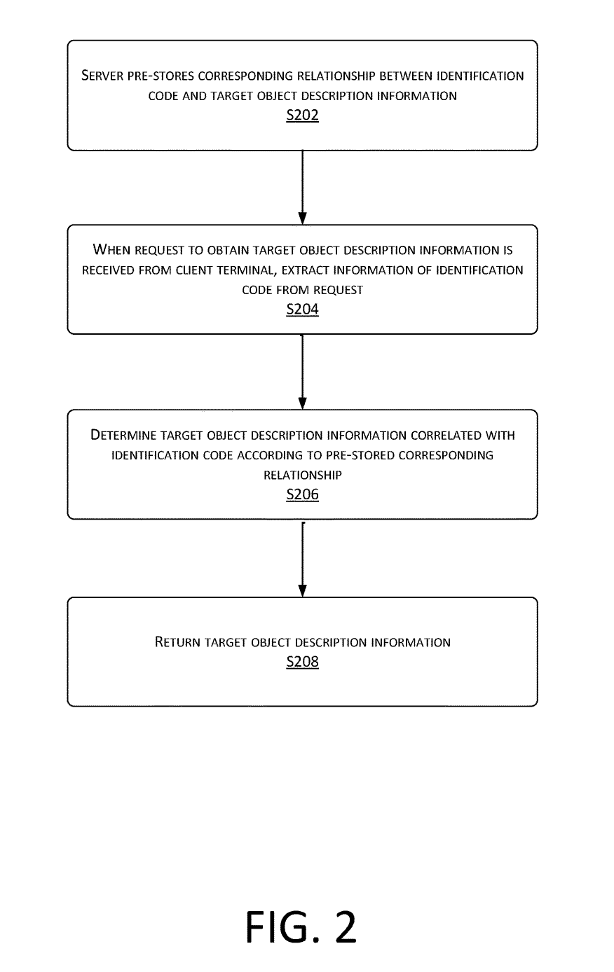

Referring to FIG. 2, the second embodiment of the present disclosure provides a method for providing logistics content information, which may include the following steps.

S202: A server pre-stores a corresponding relationship between an identification code and target object description information.

S204: When a request to obtain target object description information is received from a client terminal, information of the identification code is extracted from the request. After the graphic code on the target courier waybill is obtained via scanning by an image capturing device, the client terminal analyzes and extracts the identification code from the graphic code and sends the request.

S206: The target object description information associated with the identification code is determined according to the pre-stored corresponding relationship.

S208: The target object description information is returned so that a terminal device where the client terminal resides displays the target object description information to preview the product in the corresponding carrier parcel.

In a detailed implementation, when the pre-stored corresponding relationship at the server also includes preview privilege information, such privilege information may also be used to conduct privilege authentication of the client terminal. When the authentication passes, the steps for returning the target object description information is triggered.

The preview privilege information may include password information. When the client terminal is conducted privilege authenticated by using the privilege information, an option to input password is firstly provided. After receiving the password information uploaded by the client terminal, such password information is compared with the password information stored in the corresponding relationship. When there is a match, the authentication passes.

The third embodiment is as follows.

The third embodiment corresponds to the second embodiment, and describes the detailed implementation of providing the target object description information from the perspective of the client terminal.

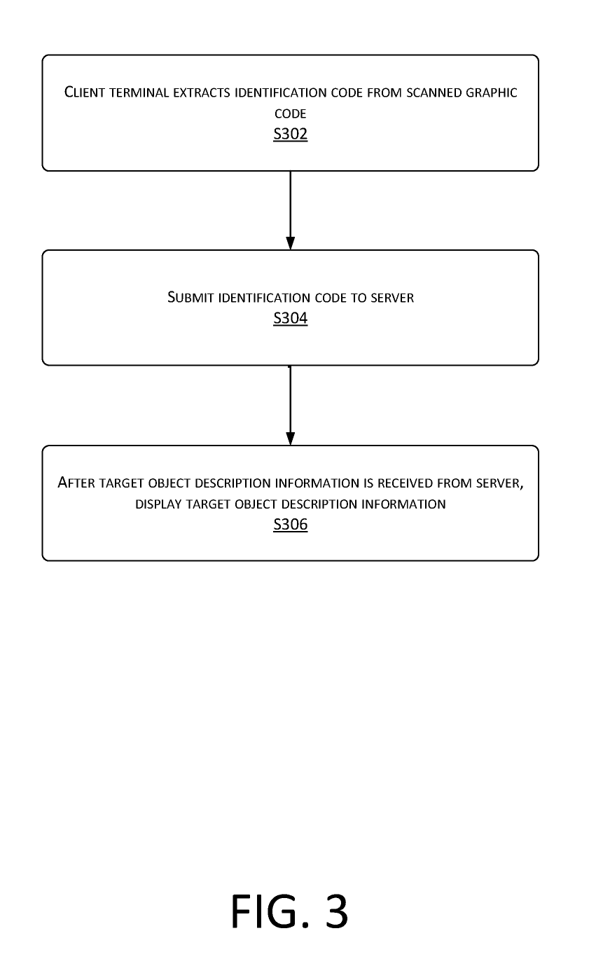

Referring to FIG. 3, the third embodiment of the present disclosure provides a method for providing logistics content information, which may include the following steps:

S302: A client terminal extracts an identification code from a scanned graphic code. The graphic code is a graphic code printed on a carrier waybill.

S304: The identification code is submitted to a server so that the server determines and returns target object description information associated with the identification code according to a pre-stored corresponding relationship between the identification code and the target object description information.

S306: After the target object description information is received from the server, the client terminal displays the target object description information to preview the product in the carrier parcel.

The display of the target object description information may use the augmented reality technology. That is, the location of the scanned object (such as the carrier waybill barcode number) on the screen of the terminal device is used as the coordinate to display the target object description information.

The above second embodiment and third embodiment correspond to the first embodiment. Thus, the relevant implementation details may refer to the description of the first embodiment, which are not detailed herein.

The fourth embodiment is as follows.

As shown in the first embodiment, to protect the privacy of the buyer user, the techniques of the present disclosure allow to set up the preview privilege of the target object. The fourth embodiment describes such implementation process.

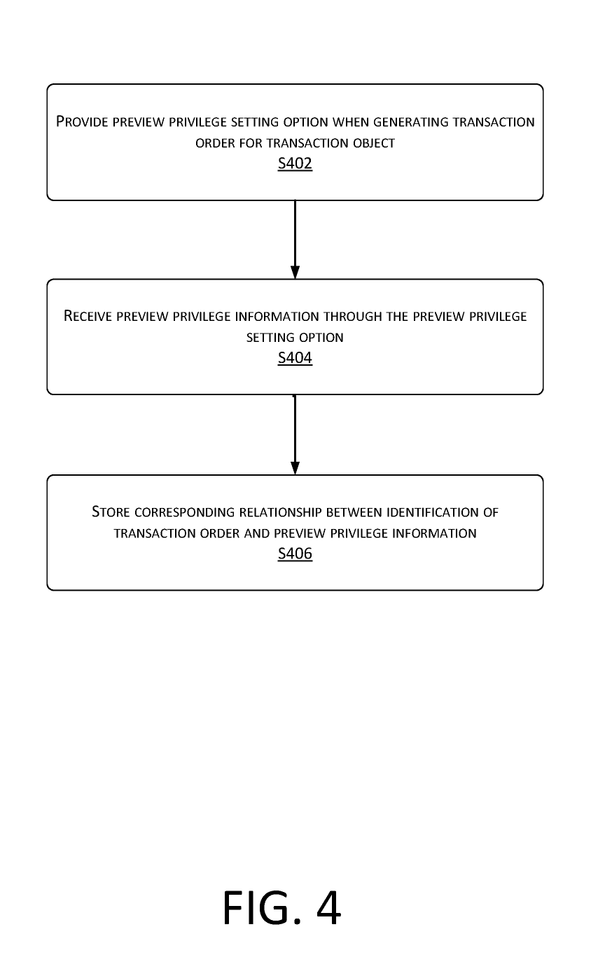

Referring to FIG. 4, the fourth embodiment of the present disclosure provides a method for generating a transaction order, which may include the following steps:

S402: providing a preview privilege setting option when generating a transaction order for a transaction object, wherein the preview privilege setting option is used to set corresponding preview privilege information when the parcel content is previewed by scanning the graphic code printed on the carrier waybill;

S404: receiving preview privilege information through the preview privilege setting option; and

S406: storing a corresponding relationship between an identification of the transaction order and the preview privilege information.

The preview privilege information includes password information. When the content of the carrier parcel is previewed through scanning the graphic code printed on the carrier waybill, the password information is used for privilege control.

The detailed implementation of the fourth embodiment may refer to relevant descriptions of the first embodiment, which is not detailed herein.

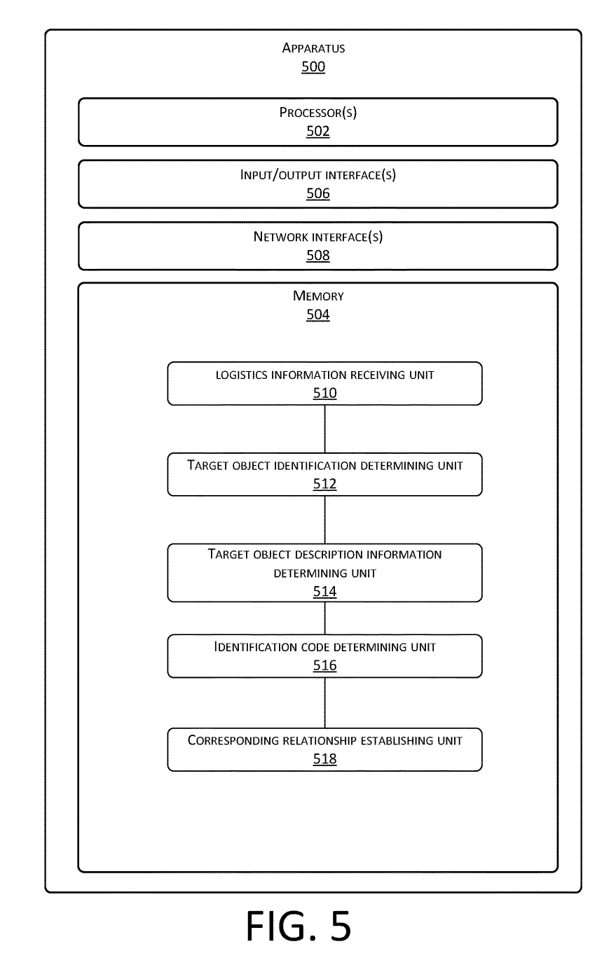

Corresponding to the method for correlating carrier information as provided in the first embodiment, the present disclosure also provides an apparatus for correlating courier information. Referring to FIG. 5, an apparatus 500 includes one or more processor(s) 502 or data processing unit(s) and memory 504. The apparatus 500 may further include one or more input/output interface(s) 506 and one or more network interface(s) 508. The memory 504 is an example of computer readable media.

The computer readable media include non-volatile and volatile media as well as movable and non-movable media, and can implement information storage by means of any method or technology. Information may be a computer readable instruction, a data structure, and a module of a program or other data. A storage medium of a computer includes, for example, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission media, and can be used to store information accessible to the computing device. According to the definition herein, the computer readable media do not include transitory media, such as modulated data signals and carriers.

The memory 504 may store therein a plurality of modules or units including:

a logistics information receiving unit 510 that receives logistics information entered for a target transaction order;

a target object identification determining unit 512 that determines a target transaction object identification associated with the target transaction order;

a target object description information determining unit 514 that determines target object description information corresponding to the target transaction object identification;

an identification code determining unit 516 that determines an identification code, wherein the identification code is printed on a target courier waybill in a form of graphic code; and

a corresponding relationship establishing unit 518 that establishes and stores a corresponding relationship between the identification code and the target object description information, such that when the graphic code on the target courier waybill is scanned by an image capturing device, the target object description information is displayed at the image capturing device to provide a preview of the product in the corresponding courier parcel.

In a specific implementation, the apparatus may also include:

a database establishing unit that provides a database of transaction object content description information, which stores the corresponding relationship between the transaction object identification and the target object description information.

The target object description information determining unit 514 may further include an inquiry sub-unit that searches the database and determines the target object description information corresponding to the transaction object identification.

In another implementation, the target object identification determining unit 512 may include:

a detailed description information obtaining sub-unit that obtains the detailed description information of the target transaction object; and

a content description information extracting sub-unit that extracts the target content description information corresponding to the target transaction object from the detailed description information.

The identification code determining unit 516 may include a carrier waybill identification extracting sub-unit that extracts the target carder waybill identification from the logistics information and determines the target carrier waybill number as the identification number.

Alternatively, the identification code determining unit 516 may include an identification code generating sub-unit that generates the identification code according to a preset rule. The apparatus may also include:

a graphic code generating unit that generates the graphic code according to the generated identification code; and

a graphic code information returning unit that returns the generated graphic code information to print the generated graphic code on the target carrier waybill.

In the actual implementation, the apparatus may further include:

a preview privilege information determining unit that determines the preview privilege information associated with the target transaction order;

a preview privilege information storing unit that stores the preview privilege information when storing the corresponding relationship between the target carrier waybill identification number and the target object description information.

The view privilege information includes password information so that when the image capturing device scans the target waybill number, the privilege control is conducted through password authentication.

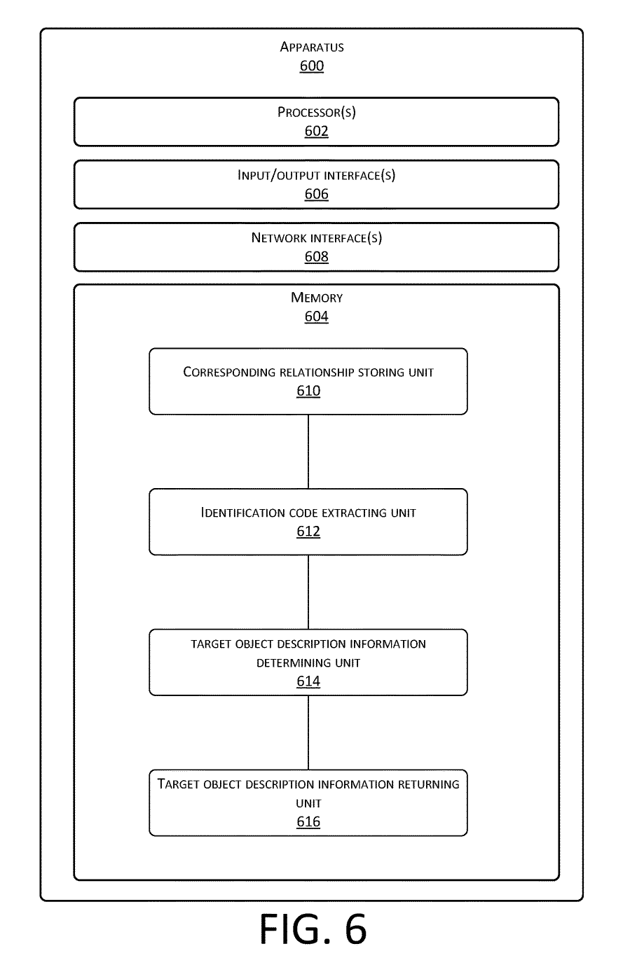

Corresponding to method for providing the logistics content information in the second embodiment of the present disclosure, referring to FIG. 6, the present disclosure also provides an apparatus 600 for providing logistics content information. The apparatus 600 includes one or more processor(s) 602 or data processing unit(s) and memory 604. The apparatus 600 may further include one or more input/output interface(s) 606 and one or more network interface(s) 608. The memory 604 is an example of computer readable media.

The memory 604 may store therein a plurality of modules or units including:

a corresponding relationship storing unit 610 that a server pre-stores a corresponding relationship between an identification code and target object description information;

an identification code extracting unit 612 that, when a request to obtain target object description information is received from a client terminal, extracts information of the identification code from the request. After the graphic code on the target courier waybill is obtained via scanning by an image capturing device, the client terminal analyzes and extracts the identification code from the graphic code and sends the request;

a target object description information determining unit 614 that determines the target object description information associated with the identification code according to the pre-stored corresponding relationship and

a target object description information returning unit 616 that returns the target object description information so that a terminal device where the client terminal resides displays the target object description information to preview the product in the corresponding carrier parcel.

The pre-stored corresponding relationship may also include preview privilege information. The apparatus may further include a privilege authentication unit that uses the preview privilege information to conduct privilege authentication of the client terminal. If the authentication passes, the steps for returning the target object description information are triggered.

The preview privilege information may include password information. The privilege authentication unit may include:

an option providing sub-unit that provide an option to input password information; and

a password receiving sub-unit that, after receiving the password information uploaded by the client terminal, compares such password information with the password information stored in the corresponding relationship, and passes the authentication if there is a match.

Corresponding to the method for providing the logistics content information provided by the third embodiment of the present disclosure, the present disclosure also provides an apparatus for providing logistics content information.

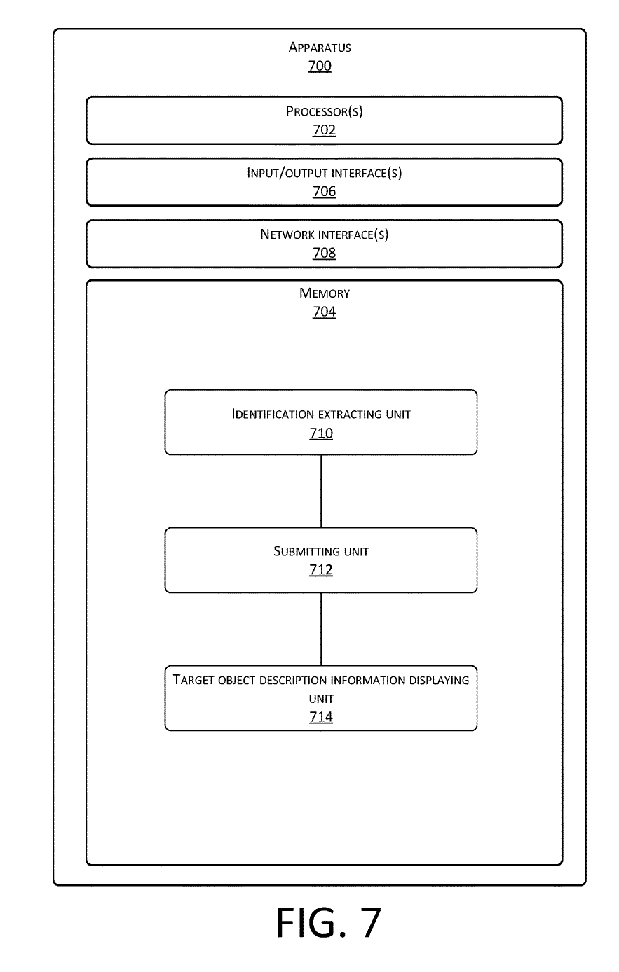

Referring to FIG. 7, an apparatus 700 includes one or more processor(s) 702 or data processing unit(s) and memory 704. The apparatus 700 may further include one or more input/output interface(s) 706 and one or more network interface(s) 708. The memory 704 is an example of computer readable media.

The memory 704 may store therein a plurality of modules or units including:

an identification extracting unit 710 that extracts an identification code from a scanned graphic code. The graphic code is a graphic code printed on a carrier waybill;

a submitting unit 712 that submits the identification code to a server so that the server determines and returns target object description information associated with the identification code according to a pre-stored corresponding relationship between the identification code and the target object description information; and

a target object description information displaying unit 714 that, after the target object description information is received from the server, displays the target object description information to preview the product in the carrier parcel.

The target object description information displaying unit 714 uses the location of the scanned graphic code on the screen of the terminal device as the coordinate to display the target object description information.

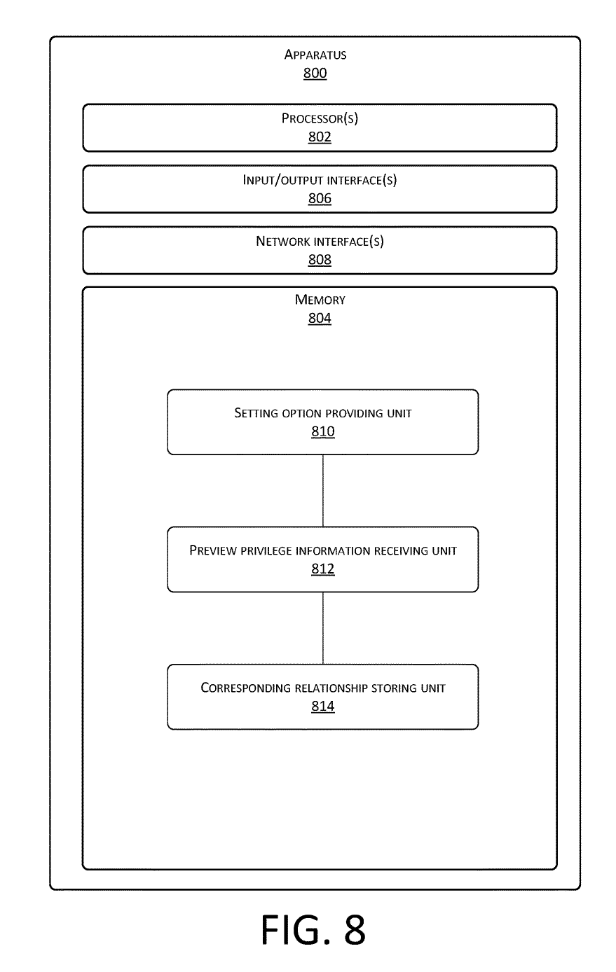

Corresponding to the method for the generating the transaction order provided by the fourth embodiment, the present disclosure also provides an apparatus for generating the transaction order. Referring to FIG. 8, an apparatus 800 includes one or more processor(s) 802 or data processing unit(s) and memory 804. The apparatus 800 may further include one or more input/output interface(s) 806 and one or more network interface(s) 808. The memory 804 is an example of computer readable media.

The memory 804 may store therein a plurality of modules or units including:

a setting option providing unit 810 that provides a preview privilege setting option when generating a transaction order for a transaction object, wherein the preview privilege setting option is used to set corresponding preview privilege information when the parcel content is previewed by scanning the graphic code printed on the carrier waybill;

a preview privilege information receiving unit 812 that receives preview privilege information through the preview privilege setting option; and

a corresponding relationship storing unit 814 that stores a corresponding relationship between an identification of the transaction order and the preview privilege information.

The preview privilege information may include password information. When the parcel content is previewed by scanning the graphic code printed on the carrier waybill, the password information is used for privilege authentication.

From the above descriptions of the embodiments, one of ordinary skill in art may clearly understand that the present disclosure may be implemented by software and necessary general-. purpose hardware platform. Based on such understanding, the essence of the technical solutions of the present disclosure or the portions thereof that contribute to the improvements of the conventional techniques may be embodied in a form of software products. The computer software products may be stored in computer readable media, such as ROM/RAM, hard disk, optical disk, etc., and computer-readable instructions that stored on the computer readable media that causes a computing device (Such as a personal computer, a server, or a network device) that implements the various embodiments of the present disclosure or some methods described by some embodiments of the present disclosure.

The various embodiments of the present disclosure are described a progressive manger. The same or similar portions of the various embodiments may refer to each other. Each embodiment emphasizes its difference from the other embodiments. Specifically, with respect to systems or system embodiments, as they are basically similar to the method embodiments, they are described relatively briefly and the relevant portions may refer to corresponding portions of the method embodiments. The above described systems and system embodiments are just illustrative. The modules or units described as separate units may be or may be not physical units, may locate at one location, or may distribute at various network units. A portion of all of the modules may be selected to implement the purpose of the embodiments of the present disclosure according to actual needs. One of ordinary skill in art may understand and implement the embodiments of the present disclosure without using creative efforts.

The above descriptions describe the method and apparatus for correlating logistics information and providing the logistics content information in detail. The present disclosure uses specific examples to illustrate the principles and implementations of the present disclosure. At the meantime, one of ordinary skill in the art may change the specific implementations and the application scope according to the principles of the present disclosure. Overall, the descriptions of the specification shall not be construed as limitations to the present disclosure.

What is claimed is:

1. A method comprising:
extracting, by a client terminal, an identification code of a carrier parcel;
searching target object description information associated with the identification code according to a pre-stored corresponding relationship between the identification code and the target object description information, the target object description information including information of a product within the carrier parcel; and
displaying the target object description information to preview the product.

2. The method of claim 1, wherein the displaying the target object description information to preview the product includes:
displaying the product using augmented reality without opening the carrier parcel.

3. The method of claim 1, wherein the extracting the identification code of the carrier parcel includes:
scanning a graphic code on a carrier waybill of the carrier parcel; and
extracting the identification code from the graphic code.

4. The method of claim 1, wherein the displaying the target object description information to preview the product includes:
determining a location of the scanned graphic code on a screen of the client terminal; and
displaying the target object description information on the location.

5. The method of claim 1, wherein the searching target object description information associated with the identification code includes:
submitting the identification code to a server to determine the target object description information associated with the identification code; and
receiving the target object description information from the server.

6. The method of claim 1, further comprising:
presenting an interface to receive preview privilege information; and
obtaining the target object description information to preview the product according to the preview privilege information.

7. A method comprising:
determining, by a server, a target transaction object identification associated with a target transaction order;
determining target object description information corresponding to the target transaction object identification;
determining an identification code of a target courier waybill; and
establishing and storing a corresponding relationship between the identification code and the target object description information.

8. The method of claim 7, wherein the identification code is printed on the target courier waybill in a form of graphic code.

9. The method of claim 7, further comprising:
receiving a request to obtain the target object description information from a client terminal;
extracting the identification code from the request; and
determining the target object description information associated with the identification code according to the corresponding relationship.

10. The method of claim 9, further comprising transmitting the target object description information to the client terminal.

11. The method of claim 7, further comprising:
establishing a database of transaction object content description information that stores the corresponding relationship.

12. The method of claim 11, wherein the determining the target object description information corresponding to the target transaction object identification includes:
searching the database; and
determining the target object description information corresponding to the target transaction object identification.

13. The method of claim 7, wherein the determining the target object description information corresponding to the target transaction object identification includes:
obtaining detailed description information of the target transaction object; and
extracting the target object description information corresponding to the target transaction object from the detailed description information.

14. The method of claim 7, wherein the determining the identification code includes:
extracting a target carrier waybill identification from logistics information of the target transaction order; and
determining the target carrier waybill identification as the identification code.

15. The method of claim 14, further comprising:
generating a graphic code as the identification code according to the generated identification code; and
returning the generated graphic code to be printed on the target carrier waybill.

16. The method of claim 7, further comprising:
determining preview privilege information associated with the target transaction order; and
storing the preview privilege information.

17. The method of claim 16, further comprising:
receiving preview privilege information from a client terminal; and
comparing the preview privilege information from the client terminal with the preview privilege information associated with the target transaction order to provide the target object description information for preview at the client terminal.

18. A method comprising:
providing a preview privilege setting option to set corresponding preview privilege information for preview a product within a carrier parcel;
receiving preview privilege information through the preview privilege setting option; and
storing a corresponding relationship between an identification of a transaction order for the product and the preview privilege information.

19. The method of claim 18, wherein the preview privilege information includes password information.

20. The method of claim 18, further comprising:
conducting a privilege control to preview the product based on the preview privilege information.
